(19) United States
(12) Patent Application Publication
(10) Pub. No.: US 2005/0151020 A1
(43) Pub. Date: Jul. 14, 2005

(54) Pneumatic conversion system

(75) Inventors: Thomas S. Marotta, Boonton Township, NJ (US); Peter Tartaglia, Butler, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Marotta Scientific Controls, Inc., Montville, NJ (US)

(21) Appl. No.: 10/387,185

(22) Filed: Mar. 12, 2003

(51) Int. Cl. B64D 1/08

(52) U.S. Cl. 244/137.1

(57) ABSTRACT

A pneumatically actuated ejection rack system for an aircraft includes a storage tank for storing a pressurized gas at or above a first pressure level and a pressure reducer positioned downstream from the storage tank. The pressure reducer is adapted to reduce the pressure level of the pressurized gas so as to receive the pressured gas at the first pressure level and discharge the pressurized gas at a second pressure level lower than the first pressure level, whereby the second pressure level is sufficient to operate a firing mechanism of the ejection rack system.

### BACKGROUND OF THE INVENTION

The present invention generally relates to store ejector racks for aircraft and more specifically relates to pneumatically actuated store ejector racks.

As used herein, the term “store” refers to munitions, e.g., bombs or other materials dropped from an aircraft. Typically, military aircraft are used to dispense such stores in flight using racks located beneath the wings and/or fuselage. When a store is released, it is typically ejected away from the aircraft using explosive cartridges that are ignited to generate high pressure gas. The high pressure gas is directed against the store for jettisoning the store from the aircraft. Such a system is shown in U.S. Pat. No. 3,598,341, which discloses a store carrier having two ejection pistons driven by high pressure gas. The high pressure gas is generated by explosive cartridges.

FIG. 1 shows a prior art store ejection system 10 which uses two cartridge actuation devices 12A, 12B, commonly referred to as CADS, to generate gas pressure to open the suspension hooks and eject the store away from the aircraft. An auxiliary release uses one additional CADS 14 to open the hooks only, providing gravity release of the store in case of primary ejector failure. Although the use of pyrotechnics to jettison or eject store from aircraft has proven useful, there are a number of major drawbacks associated with the use of pyrotechnic ejection systems. First, the ejector rack system is frequently contaminated due to the presence of pyrotechnic material, requiring removal of the rack for decontamination after several firings. Moreover, pyrotechnic devices are generally dangerous, require special handling and provide inconsistent blast performance, which results in every-changing behavior of the ejector rack system. Moreover, pyrotechnic charges are inherently unrepeatable leading to inconsistency of behavior of the ejector rack system.

In response the above problems, U.S. Pat. No. 5,583,312 discloses a cold gas ejector rack which employs on-board pressurization capability, employing a single pressurization system for two or more release mechanisms, and uses clean non-pyrotechnic pressurized gases both as the energy source and the energy transfer medium. Using pressurized, purified air eliminates the excessive cleaning burden imposed when using state-of-the-art pyrotechnics, and eliminates the sealing problems associated with hydraulics. The '312 patent uses a compressor that must be continuously activated and deactivated to reach appropriate charging levels, which results in excessive wear-and-tear on the compressor.

U.S. Pat. No. 4,095,762 to Holt discloses a system that uses stored gas (nitrogen) as an energy source, and a hydraulic subsystem as an energy transfer medium for actuating the ram ejectors. Although the '762 patent provides an advance over pyrotechnic cartridges, the system disclosed therein is relatively complicated, requires a dual fluid system, and has no onboard pressure replenishment system. Thus, as the pressure level varies due to temperature changes, so too does performance of the ram ejectors.

In view of the above disclosed shortcomings, there is a need to eliminate the problems associated with using pyrotechnic cartridge actuation devices. There is also a need for an ejector rack system that replaces pyrotechnic devices with a pneumatic system consisting of a compressor and valve arrangement, without changing any other internal components. Such a system should allow for greater ease of handling, storage and maintenance, and offer the end user significant life cycle advantages. The system should also provide an ability to safety check for correct operation prior to installation of a store.

### SUMMARY OF THE INVENTION

The present invention discloses a pneumatically actuated ejection rack system for an aircraft including a storage tank for storing a pressurized gas at or above a first pressure level and a pressure reducer positioned downstream from the storage tank. In certain preferred embodiments, the pressure reducer is adapted to reduce the pressure level of the pressurized gas so as to receive the pressurized gas at the first pressure level and discharge the pressurized gas at a second pressure level lower than the first pressure level, whereby the second pressure level is sufficient to operate a firing mechanism of the ejection rack system.

The pneumatically actuated ejection rack system also preferably includes a firing valve positioned between the storage tank and the firing mechanism, wherein the firing valve is movable between a closed position and an open position for providing the pressurized gas to the firing mechanism of the ejection rack system. In certain preferred embodiments, the firing valve is a two way/two position valve.

The system also preferably includes a compressor in communication with the storage tank for supplying the pressurized gas to the storage tank. The compressor may be activated pre-flight, during flight or post-flight. The storage tank desirably includes a charging port for receiving the pressurized gas. The charging port enables the pressurized gas to be introduced into the storage tank without activating the compressor. This charging may take place before flight without activating the compressor for saving wear-and-tear on the compressor.

The system may also include a pressure gauge for monitoring the pressure level of the pressurized gas in the storage tank, and a pressure switch for activating the compressor if the monitored pressure level of the pressurized gas falls below the first pressure level, or another predetermined pressure level. Preferably, the desired pressure level to be maintained in the storage tank can be selected and changed.

In certain preferred embodiments, the pressure reducer includes an inlet for receiving the pressurized gas at the first pressure level and an outlet for discharging the pressurized gas at the second pressure level less than the first pressure level. The pressure reducer is normally open in certain preferred embodiments.

The system desirably includes an isolation valve located between the pressure reducer and the firing valve. The isolation valve may be a three way/two position solenoid actuated valve. The isolation valve is normally closed in preferred embodiments. In certain preferred embodiments, the isolation valve and firing valve are opened simultaneously for operating the firing mechanism. The dual, simultaneous operation of the isolation and firing valves for activating the firing mechanism prevents accidental jettisoning of store should only one of the devices (i.e. either the isolation valve or the firing valve) fail.

In certain preferred embodiments, the pneumatically actuated ejection system also includes an auxiliary ejection system having an auxiliary storage tank adapted for selectively storing the pressurized gas, an auxiliary release mechanism for jettisoning store from the aircraft and an auxiliary valve for selectively providing the pressurized gas to the auxiliary release mechanism.

In other preferred embodiments of the present invention, a pneumatically actuated ejection rack system for an aircraft includes a storage tank for storing a pressurized gas at or above a first pressure level, and a pressure reducer positioned downstream from the storage tank for receiving the pressurized gas from the storage tank and discharging the pressurized gas at a second pressure level that is lower than the first pressure level. The system also preferably includes a firing valve in communication with the pressure reducer, the firing valve being movable between a first closed position and a second open position, and a firing mechanism positioned downstream from the pressure reducer and the firing valve. The pressurized gas discharged from the pressure reducer at the second pressure level is sufficient to operate the firing mechanism for activating the ejection rack system. The firing valve is preferably normally closed and is movable to the second open position for supplying the pressurized gas to the firing mechanism.

In preferred embodiments, the system also includes an isolation valve positioned between the pressure reducer and the firing valve, whereby the isolation valve and the firing valve are adapted to open simultaneously for preventing a single point of failure resulting in accidental activation of the firing mechanism. In other preferred embodiments, the isolation valve and the firing valve may be opened in series. For example, the isolation valve may be opened first to prime the system and the firing valve opened after the isolation valve has been opened to activate the firing mechanism.

These and other preferred embodiments of the present invention will be described in more detail below.

### BRIEF DESCRIPTION OF THE DRAWINGS

FIG. 1 shows a prior art store ejection system for an aircraft.

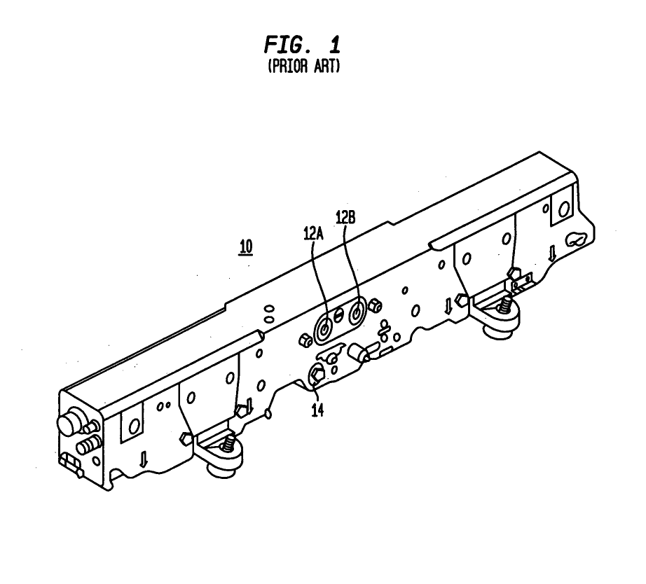

FIG. 2 shows a pneumatic ejection rack system including a pressure reducer, in accordance certain preferred embodiments of the present invention.

FIG. 3 shows a schematic view of the pneumatic ejection rack system of FIG. 2.

FIG. 4 shows a pneumatic conversion system incorporating the pneumatic ejection rack system of FIG. 2, in accordance further preferred embodiments of the present invention.

### DETAILED DESCRIPTION

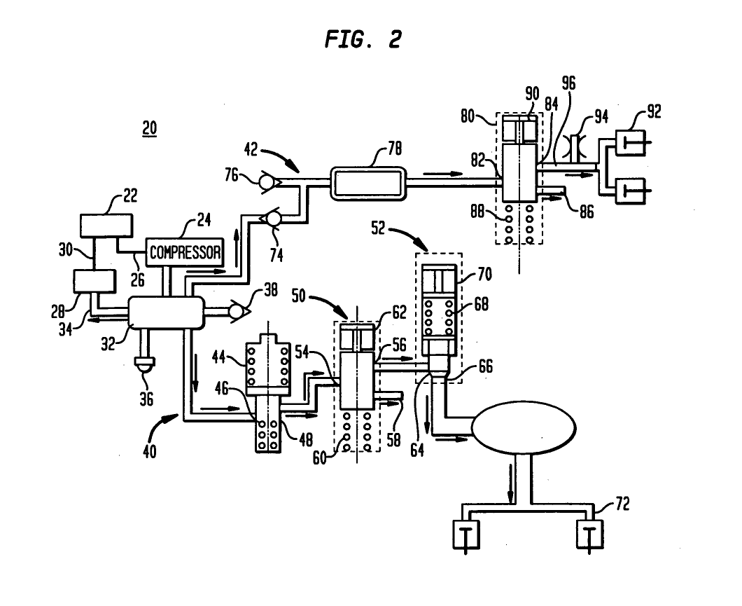

FIG. 2 shows a pneumatic ejection rack system 20 for ejecting store from an aircraft. The system includes a controller 22 that controls the overall operation of the system. In certain preferred embodiments, the controller converts signals from a pilot or member of a light crew for use by the system 20, monitors pressure levels within storage tanks holding pressurized gas and signals when compressors must be activated and deactivated.

The system preferably includes a compressor 24 that may be selectively activated and deactivated for producing pressurized gas. In certain preferred embodiments, the pressurized gas is ambient air that is drawn into the compressor through inlet ports (not shown) and compressed into pressurized gas having a pressure range between 2,000 and 12,000 psi. Preferred pressure ranges may vary in other embodiments. In certain preferred embodiments, compressor 24 is a reciprocal (i.e. piston) compressor, however, other compressors such as rotary, screw and centrifugal compressors may also be used. The compressor 24 is in communication with controller 22 via control line 26. The system 20 also includes a pressure switch 28 in communication with controller 22 via a second communication line 30. The pressure switch preferably monitors real time pressure within a storage tank 32 and signals when to activate and deactivate compressor 24. Storage tank 32 stores the pressurized gas produced by compressor 24. Storage tank 32 includes a line 34 in communication with pressurized switch 28 so that the internal pressure of the pressurized gas within storage tank 32 may be constantly monitored. Storage tank 32 also includes a rupture disk 36 that will release pressure when the internal pressure of the gas exceeds a predetermined level. In one preferred embodiment, the rupture disk 36 is designed to rupture when the internal pressure of the gas is at or above 12,000 psi. This will prevent the storage tank from bursting at elevated pressure levels. In one highly preferred embodiment, the output of compressor 24 is approximately 6,000 psi at all times. As the ambient temperature of the air around the compressor drops, the pressure of the gas within the compressor will also drop, but preferably never less than 5,100 psi. On the other hand, as the ambient pressure around the compressor increases, the internal pressure of the gas within the compressor will also rise to a maximum of preferably 8,500 psi. As is well known to those skilled in the art, the change in the internal pressure of the gas within the compressor may be the result of ambient temperature fluctuations during flight, and not related to the output or performance of the compressor 24. In other preferred embodiments, the ruptured disc may be designed to release pressure at different predetermined pressure levels. As noted above, in one preferred embodiment the pressure level is 12,000 psi. In other embodiments, however, the pressure level may be lower, such as 10,000 psi.

The system also preferably includes a charging port 38 in communication with storage tank 32. The charging port 38 enables pressurized gas to be introduced into storage tank 32. This design preferably saves wear and tear on the compressor 24, as the compressor 24 does not have to be used to initially pressurize storage tank 32. In one preferred embodiment, the pressurized gas is introduced through charging port 38 when the aircraft is on the ground so that the compressor 24 does not have to be activated during flight to pressurize storage tank 32.

The pneumatic ejector rack system also preferably includes a main firing branch 40 and an auxiliary firing branch 42. The main firing branch 40 includes a pressure reducer 44 having an inlet side 46 and an outlet side 48. The pressurized gas introduced in the inlet side 46 is reduced to a consistent and preferably lower pressure level at outlet side 48. As a result, the pressure level of pressurized gas discharged through outlet 48 is constant regardless of the inlet pressure at inlet side 46. In certain preferred embodiments, the pressure reducer 44 is normally open. The main firing branch also includes a double safety feature to prevent undesired activation of the firing system. In certain preferred embodiments, the double safety feature includes an isolation valve 50 and a firing valve 52. In one preferred embodiment, the isolation valve 50 includes an inlet 54, an outlet 56 and a vent 58. The isolation valve preferably includes a spring 60 for normally closing the valve 50 and electric coils 60 that may be energized for overcoming the closing force of the spring and moving the valve into the open position. When the valve is in the open position, the pressurized gas passes though inlet 54 and is discharged from outlet 56 downstream to interface with firing valve 52. In certain preferred embodiments, isolation valve 50 is a three-way/two position solenoid actuated valve.

The pneumatic ejector rack system 20 also preferably includes firing valve 52 including inlet 64 and outlet 66. The firing valve preferably includes spring 68 that normally holds the firing valve in a closed position. Firing valve 52 also includes electric coils 70 that may be energized for overcoming the force of spring 68 to move the firing valve 52 into an open position. When the isolation valve and firing valve 52 are simultaneously opened, the pressurized gas passes downstream to the one or more ejection racks for ejecting store from the aircraft. In certain preferred embodiments, the ejection racks are similar to those disclosed in U.S. Pat. Nos. 4,043,525; 4,347,777 and 5,583,321.

The pneumatic ejector rack system 20 also preferably includes auxiliary firing branch 42 including a check valve 74, a charging port 76 and an auxiliary storage tank 78 adapted to store pressurized gas. The auxiliary firing branch 42 also preferably includes an auxiliary valve 80 having an inlet 82, an outlet 84 and a vent 86. The auxiliary valve 80 preferably includes one or more springs 88 that normally hold the auxiliary valve in the closed position. Auxiliary valve 80 also preferably includes solenoids 90 that may be energized for moving the auxiliary valve 80 into the open position for allowing pressurized gas to pass through outlet 84 and onto auxiliary release mechanism 92. The auxiliary branch 42 also includes a control orifice 94 that is adapted for depressurizing line 96 downstream from the auxiliary valve after the auxiliary release mechanism has been activated. This feature insures that any pressure remaining in line 96 after activation of auxiliary firing branch is discharged to the atmosphere.

In operation, the main storage tank 32 is preferably charged with pressurized gas through charging port 38. Charging the storage tank 32 while the aircraft is on the ground saves wear and tear on compressor 24. In certain preferred embodiments, the firing mechanism require pressure of at least 6,000 psi for successfully activating the system and ejecting the store from the aircraft. As such, the pressure of the pressurized gas within the storage tank 32 is preferably well above 6,000 and is preferably in the 7,000-9,000 psi range. As a result, the pressure of the gas within the storage tank 32 will always be well above the minimum pressure needed by the firing mechanism, even if the pressure drops due to lower temperatures at higher altitudes. In the event that the pressure within the storage tank falls below a predetermined level, the pressure switch 28 will be activated for activating compressor 24 so as to produce sufficient pressurized gas at or above the predetermined pressure level. If the pressurized gas within the storage tank 32 is above a rupture level (e.g. 12,000 psi), the rupture disc 36 will rupture for releasing the pressurized gas to atmosphere, thereby preventing bursting of storage tank 32.

When a pilot seeks to jettison store by activating the main release mechanism, the electric coils 62, 70 of the respective isolation valve 50 and firing valve 52 are simultaneously energized so as to simultaneously move the isolation valve and firing valve into the open position. At that time, pressurized gas from storage tank 32 will enter inlet 46 of pressure reducer 44 and exit outlet 48 at a predetermined temperature. In one preferred embodiment, the pressure reducer 44 reduces the pressure of the gas to a predetermined level, such as 6,000 psi, regardless of the pressure level of the gas entering inlet 46. As a result, a pressurized gas at a constant pressure level will also be discharged from the outlet 48. The pressurized gas will then pass through the open isolation valve 50 and the open firing valve 52 and onto the main release mechanism for jettisoning and ejecting store from the ejection racks. After the pressurized gas has been used to eject the store, the isolation valve 50 and the firing valve 52 are moved to a closed position. At that point, the required pressure in the storage tank will most likely be below the desired level. The pressure switch will monitor the internal pressure of the storage tank and determine that the pressure therein is too low. If the pressure level is too low, the pressure switch 28 will send a signal activating compressor 24 to repressurize the air or gas within storage tank 32. When a sufficient pressure level has been attained, the pressure switch will turn the compressor 24 off. The system is then ready for ejecting other store from the aircraft.

In the event that the main branch 40 fails, the auxiliary branch 42 may be used to eject the store. The auxiliary branch may also be used due to the occurrence of other events such as electronic issues, ilot error, improperly loaded store, etc. In order to use the auxiliary branch, the check valve 74 is preferably moved to an open position so that the pressurized gas within the main tank 32 may be passed downstream to the auxiliary release mechanism. In certain preferred embodiments, a charging port 76 may be used to introduce pressurized gas into an auxiliary storage tank 78. The auxiliary valve 80 may then be activated for moving the auxiliary valve into an open position such as by energizing coils 90 so as to overcome the closing force provided by springs 88, whereby pressurized gas may pass through inlet 32, exit through outlet 34 and travel downstream to auxiliary release mechanism 92. After the store has been ejected using the auxiliary branch 42, the auxiliary valve 80 is moved to the closed position, preferably by de-energizing the coils 90. Any pressurized gas remaining in line 96 will preferably be discharged from the system through control orifice 94. As a result, the aircraft may land safely without pressurized gas in line 96.

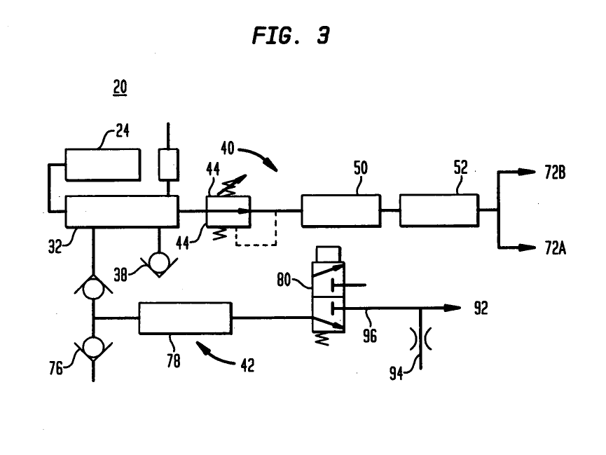

FIG. 3 shows a schematic view of the pneumatic ejection rack system of FIG. 2. The system 20 includes main branch 40 and auxiliary branch 42. The system 20 also preferably includes compressor 24, main storage tank 32, charging port 38 for main storage tank 32 and pressure reducer 44. The main branch 40 also desirably includes isolation valve 50 and firing valve 52. When the main branch is fully opened, the pressurized gas at the preferred pressure is provided to main firing mechanism 72a and 72b. The firing mechanism may include pistons that are activated by the pressurized gas for forcibly ejecting the store from the aircraft.

The auxiliary branch 42 desirably includes auxiliary charging port 76, auxiliary storage tank 78 and auxiliary valve 80 moveable between a normally closed position and an open position. The auxiliary branch 42 also desirably includes line 96 that provides pressurized gas to auxiliary release mechanism 92 when the auxiliary valve 80 is in the open position. The auxiliary branch 42 also includes a control orifice 94 that enables any pressurized gas remaining in line 96 to be bled therefrom after firing the auxiliary firing mechanism. Depressurizing line 96 avoids a situation where pressurized gas is present in line 96 when an aircraft lands, a potentially dangerous situation.

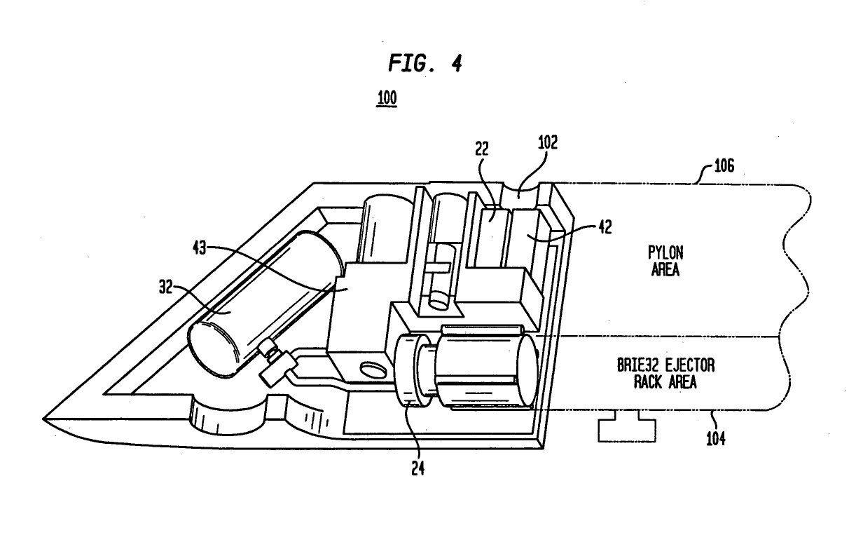

Referring to FIG. 4, in one preferred embodiment, the pneumatic ejection rack system is incorporated into a conversion kit which may be incorporated into the existing geometric envelope of a bay without modifying the existing envelope. The conversion kit 100 preferably includes a compressor 24, main storage tank 32, a manifold 43 including a pressure reducer (not shown), an isolation valve, controller 22, electrical connectors 102 and an auxiliary release mechanism 42. The conversion kit 100 is preferably installed within a pylon area 106 of an aircraft, adjacent ejection rack area 104. The conversation kit 100 generally replaces a conventional pyrotechnic ejection system with a pneumatically activated ejection system that uses pressurized gas to jettison store from an aircraft. In other preferred embodiments, there may be a teed to slightly modify the envelope. This may result from the firing valves projecting out from the rack slightly more than is the case with pyrotechnics.

Although the invention herein has been described with reference to particular embodiments, it is to be understood that these embodiments are merely illustrative of the principles and applications of the present invention. It is therefore to be understood that numerous modifications may be made to the disclosed embodiments and that other arrangements may be devised without departing from the spirit and scope of the present invention as defined by the appended claims.

1. A pneumatically actuated ejection rack system for an aircraft comprising:
a storage tank for storing a pressurized gas at or above a first pressure level;
a pressure reducer positioned downstream from said storage tank, wherein said pressure reducer is adapted to reduce the pressure level of said pressurized gas so as to receive said pressurized gas at the first pressure level and discharge said pressurized gas at a second pressure level lower than said first pressure level, wherein said second pressure level is sufficient to operate a firing mechanism of said ejection rack system.

2. The system as claimed in claim 1, further comprising a firing valve positioned between said storage tank and said firing mechanism, wherein said firing valve is movable between a closed position and an open position for providing said pressurized gas to said firing mechanism of said ejection rack system.

3. The system as claimed in claim 2, wherein said firing valve is a two way/two position valve.

4. The system as claimed in claim 1, further comprising a compressor in communication with said storage tank for supplying said pressurized gas to said storage tank.

5. The system as claimed in claim 4, wherein said storage tank includes a charging port for receiving said pressurized gas, said charging port enabling said pressurized gas to be introduced into said storage tank without activating said compressor.

6. The system as claimed in claim 4, further comprising a pressure gauge for monitoring the pressure level of said pressurized gas in said storage tank, and a pressure switch for activating said compressor if the monitored pressure level of said pressurized gas falls below the first pressure level.

7. The system as claimed in claim 1, wherein said pressure reducer includes an inlet for receiving said pressurized gas at the first pressure level and an outlet for discharging said pressurized gas at the second pressure level less than said first pressure level.

8. The system as claimed in claim 1, wherein said pressure reducer is normally open.

9. The system as claimed in claim 2, further comprising a safety valve located between said pressure reducer and said firing valve.

10. The system as claimed in claim 9, wherein said safety valve is a three way/two position solenoid actuated valve.

11. The system as claimed in claim 9, wherein said safety valve is normally closed.

12. The system as claimed in claim 9, wherein said safety valve and said firing valve are opened simultaneously for operating said firing mechanism.

13. The system as claimed in claim 1, further comprising an auxiliary ejection system including an auxiliary storage tank adapted for selectively storing said pressurized gas, an auxiliary release mechanism for jettisoning store from said aircraft and an auxiliary valve for selectively providing said pressurized gas to said auxiliary release mechanism.

14. The system as claimed in claim 1, further comprising a pressure monitor adapted to monitor the pressure level of said pressurized gas in said storage tank and generate signals for activating and deactivating a compressor.

15. A pneumatically actuated ejection rack system for an aircraft comprising:
a storage tank for storing a pressurized gas at or above a first pressure level;
a pressure reducer positioned downstream from said storage tank for receiving said pressurized gas from said storage tank at said first pressure level and discharging said pressurized gas at a second pressure level that is lower than said first pressure level;
a firing valve in communication with said pressure reducer, said firing valve being movable between a first closed position and a second open position;
a firing mechanism positioned downstream from said pressure reducer and said firing valve, wherein said pressurized gas discharged from said pressure reducer at said second pressure level is sufficient to operate said firing mechanism for activating said ejection rack system.

16. The system as claimed in claim 15, wherein said firing valve is normally closed and is movable to the second open position for supplying said pressurized gas to said firing mechanism.

17. The system as claimed in claim 15, further comprising a safety valve positioned between said pressure reducer and said firing valve, wherein said safety valve and said firing valve are adapted to open simultaneously for preventing a single point of failure resulting in accidental activation of said firing mechanism.

18. The system as claimed in claim 1, wherein said pressure reducer reduces the pressure level of said pressurized gas to the second pressure level during activation of said firing mechanism.

19. The system as claimed in claim 15, wherein said pressure reducer reduces the pressure level of said pressurized gas to said second pressure level during activation of said firing mechanism.
